(19) United States
(12) Patent Application Publication
(10) Pub. No.: US 2006/0010738 A1
(43) Pub. Date: Jan. 19, 2006

(54) Sign structure and related tool and method

(76) Inventors: James J. Roark, Tucson, AZ (US); Robert S. LeCompte, Tucson, AZ (US)

Correspondence Address: Lawrence R. Oremland, P.C., Suite C-214, 5055 E. Broadway Boulevard, Tucson, AZ, 85711, US

(21) Appl. No.: 11/165,480

(22) Filed: Jun. 23, 2005

Related U.S. Application Data
(60) Provisional application No. 60/582,589, filed on Jun. 24, 2004.

(51) Int. Cl. G09F 11/02

(52) U.S. Cl. 40/479

(57) ABSTRACT

New and useful sign structure is provided, that is designed to be (i) efficient and cost effective to produce, (ii) easily and efficiently assembled, in order to change the message conveyed by the sign structure, and (iii) effectively rotated by the air movement in the vicinity of the sign structure. The sign structure comprises a support rod, and a sign comprising a specially formed panel that is rotatable on the support rod. A bearing surface is integrally connected with the panel (preferably formed in one piece with the panel) and extends along a predetermined portion of the panel. The bearing surface is configured to slide over the support rod and to rotate on the support rod, so that the panel is rotatable about the support rod. In a preferred form, the panel comprises a synthetic material having a corrugated configuration with at least one corrugation forming the bearing surface for the panel. Additionally, in a preferred form, a pair of fins are formed in one piece with the corrugated panel, and are bent at an angle relative to the plane of the panel. Additionally, a preferred sign structure is designed in a manner that enables a planar piece of corrugated synthetic material to be efficiently formed into the sign. Specifically, a planar piece of corrugated synthetic material is formed in a way that allows the fins to be efficiently bent out of the plane of the panel, and maintained in the bent configuration, to form the sign. Additionally, a new tool is provided for use in forming the sign structure, and a new method is provided for using the tool in forming the sign structure.

### RELATED APPLICATION/CLAIM OF PRIORITY

This Application is related to and claims priority from Provisional Application Ser. No. 60/582,589, filed Jun. 24, 2004, entitled Sign Structure, which provisional application is incorporated by reference herein.

### BACKGROUND

The present invention relates to sign structure, and particularly to wind actuated rotatable sign structure that is designed to be (i) efficient and cost effective to produce, (ii) easy to assemble and disassemble, in order to change the message conveyed by the sign structure, and (iii) effectively rotated by air movement in the vicinity of the sign structure, to attract the attention of those in viewing range of the sign structure. The present invention also relates to tool structure and methods for use in forming the sign structure.

In the applicants' experience, rotating sign structures have often signs formed of aluminum, with fins at the ends of the signs, and special bearing/connecting structure that enables the signs to be connected with support frames in a manner that allows the signs to be wind actuated and effectively rotated.

Also in the applicants' experience, there are areas in which such sign structures can be further improved. For example, applicants believe such sign structures can be designed in a manner that reduces the weight of the sign structure, and can be designed to be (i) efficient and cost effective to produce, (ii) easily and efficiently assembled, in order to change the message conveyed by the sign structure, and (iii) effectively rotated by air movement in the vicinity of the sign structure, to attract the attention of those in viewing range of the sign structure.

### SUMMARY OF THE PRESENT INVENTION

The present invention relates to new and useful sign structure designed to be (i) efficient and cost effective to produce, (ii) easily and efficiently assembled, in order to change the message conveyed by the sign structure, and (iii) effectively rotated by air movement in the vicinity of the sign structure, to attract the attention of those in viewing range of the sign structure.

Sign structure according to the present invention comprises a support rod, and a sign comprising a specially formed panel that is rotatable on the support rod. A bearing surface is integrally connected with the panel (is preferably formed in one piece with the panel) and extends along a predetermined portion of the panel. The bearing surface is configured to slide over the support rod and to rotate on the support rod, so that the panel is rotatable about the support rod. In a preferred form, the panel comprises a synthetic material having a corrugated configuration with at least one corrugation forming the bearing surface for the panel. Additionally, in a preferred form, a pair of fins are formed in one piece with the corrugated panel, and are bent at an angle relative to the plane of the panel.

Additionally, a preferred sign structure according to the present invention is designed in a manner that enables a planar piece of corrugated synthetic material to be efficiently formed into the sign. Specifically, a planar piece of corrugated synthetic material is formed in a way that allows the fins to be efficiently bent out of the plane of the panel, and maintained in the bent configuration, to form the sign.

Still further, the present invention provides a new and useful tool that can be used in forming the sign structure, and to a method that uses the tool in forming the sign structure.

Further features of the present invention will become apparent from the following detailed description and the accompanying drawings and Exhibits.

### BRIEF DESCRIPTION OF THE DRAWINGS AND EXHIBITS

FIG. 1 is a schematic illustration of one embodiment of a Sign structure according to the principles of the present invention;

FIG. 2 is a schematic top view of a sign in the sign structure of FIG. 1, and specifically showing the center panel and fins forming the sign;

FIG. 2a is an enlarged, fragmentary view of the center of the sign of FIG. 2;

FIG. 3a is a schematic top view, and FIGS. 3b and 3c are schematic partial top views, of the sign of FIG. 1, as the sign is being formed and FIG. 3d is an enlarged fragmentary view of the slits shown in FIG. 3b;

FIGS. 4a and 4b are additional schematic partial top views of the sign of FIG. 1, showing stiffener wire as the sign is being formed;

FIG. 5a is a schematic three dimensional view of another embodiment of a sign structure according to the principles of the present invention;

FIGS. 5b, 5c and 5d schematically illustrate the manner in which the sign structure of FIG. 5a is assembled, according to the principles of the present invention;

FIGS. 6a, 6b and 6c are schematic illustrations of another sign structure, according to the principles of the present invention;

FIGS. 6d and 6e schematically illustrate the manner in which the sign structure of FIGS. 6a and 6b is assembled;

FIG. 6f schematically illustrates another way of supporting the sign structure of FIG. 6c;

FIGS. 7a-7e schematically illustrate components for supporting a rotatable sign structure, according to the principles of the present invention;

FIGS. 8a-8e show a tool that can be used to cut the panel of the sign structure, to form the slits shown in FIGS. 2, 3c and 4b.

Exhibits A1-A4 further show features of the tool and the method that uses the tool in forming the sign structure.

### DETAILED DESCRIPTION

As described above, the present invention relates to new and useful sign structure, and particularly to rotatable sign structure. The principles of the invention are described below in connection with several versions of a sign structure. From that description, the manner in which various types of sign structures can be constructed, according to the principles of the present invention.

One embodiment of a sign structure, according to the principles of the present invention, is shown in FIGS. 14. The sign structure 100 comprises a support rod 102, and a sign 104 that is rotatable on the support rod 102. The sign 104 comprises a center panel 106 that is generally planar, and a pair of fins 108 formed in one piece with and extending angularly out of the plane of the panel 106. By “formed in one piece” applicants mean that the fins are formed from the same piece of material that forms the panel. The center panel 106 and fins 108 are preferably formed in one piece of a synthetic material that is corrugated.

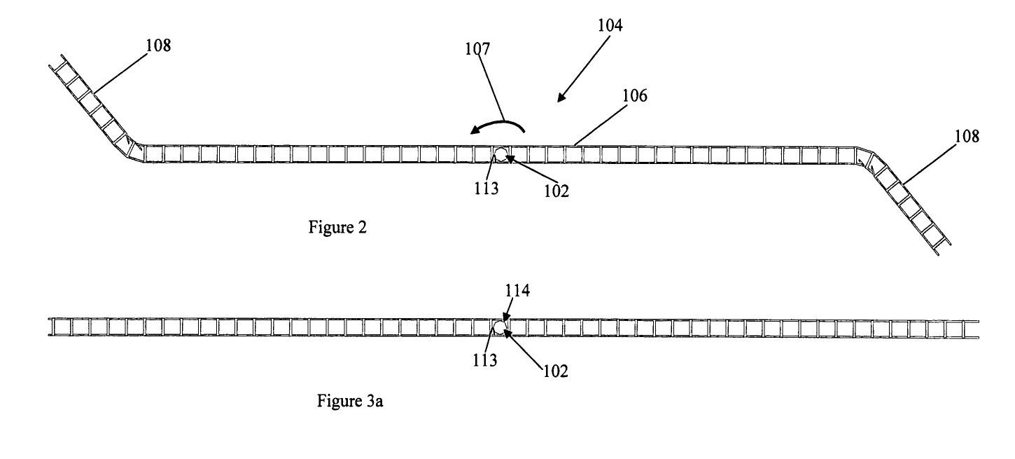

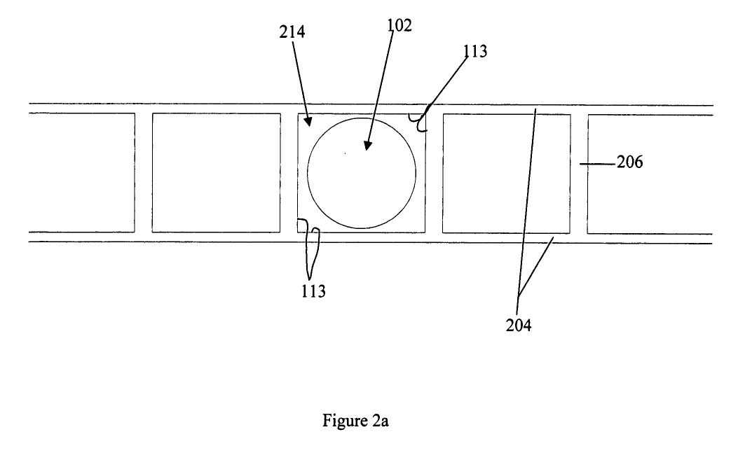

A bearing surface is integrally connected with the panel, so that the panel and bearing surface move together as a unit. According to a preferred version of the invention, at least one corrugation forms a bearing surface that extends through the center panel (from the top 110 of the center panel to the bottom 112 of the center panel). Preferably, the bearing surface comprises the inner surface 113 of a central corrugation 114 of the center panel 106 (see FIGS. 2, 2a). The bearing surface 113 is configured to slide over the support rod 102 and allows the center panel 106 to rotate on the support rod 102, so that the sign 104 rotates about the support rod. In FIG. 2, the arrow 107 depicts the direction of rotation of the sign 104 about the support rod 102, when the fins 108 are in the bent orientations shown in that figure. While it is preferred that the bearing surface is formed in one piece with the panel, the bearing surface could comprise, e.g., a bushing located in the central corrugation and fixed to the panel, so that the panel and bearing surface move together as a unit.

The sign 104 has display material that is displayed to those in viewing range of the sign 104, as the sign rotates on the support rod 102. The material may be applied to the center panel 106 and/or to the fins 108, either in a permanent form or in a removable form. If the display material is in a permanent form, changing the sign on the support rod can change the display. If the material is in a removable form, the material can be selectively removed and new material applied to the sign. In addition, the sign can also be changed, e.g. if it is desired to change the display content of the sign, if the original sign becomes worn or damaged, etc.

As can be seen from FIGS. 2, 2a, the center panel 106 extends laterally from a central corrugation 114 in which the support rod 102 is located. The central corrugation 114 has the bearing surface 113. The fins 108 are provided at the lateral ends of the center panel 106. The fins 108 extend angularly in opposite directions out of the plane of the center panel, and are configured to allow air movement in the vicinity of the panel to rotate the sign 104 about the support rod 102.

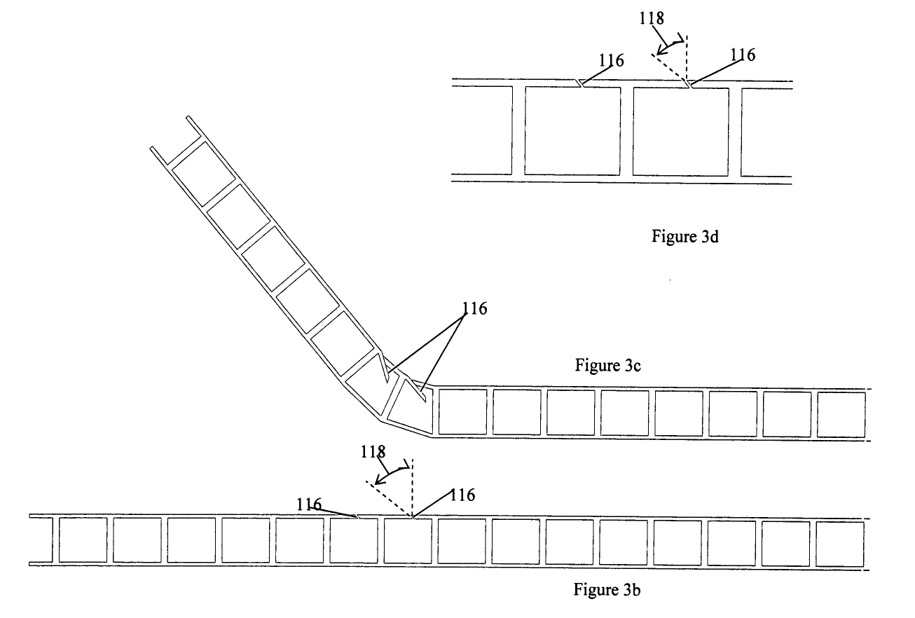

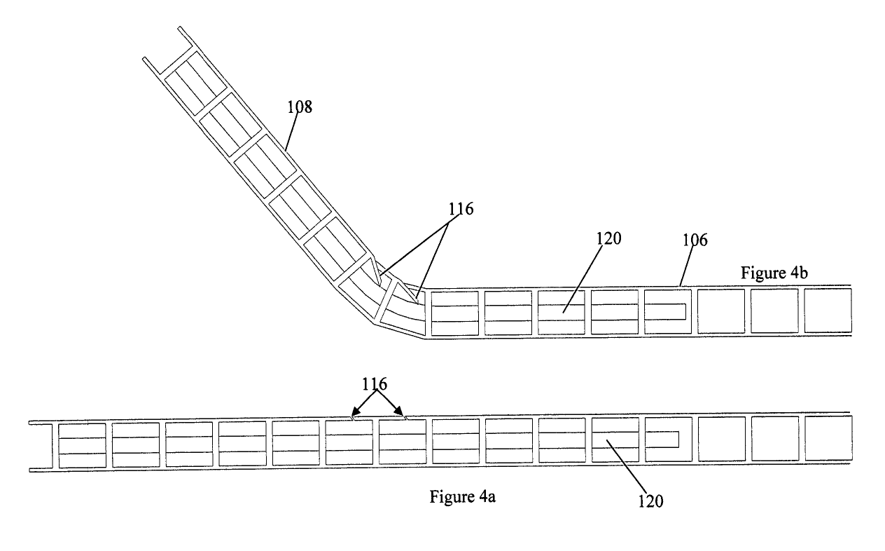

According to one preferred version of the invention, the fins 108 are bent relative to the planar center panel 106. Specifically, each fin is bent at one or more slits 116 cut at predetermined locations in an exterior wall of the corrugated material (see e.g. FIGS. 3b, 3c, 3d, 4a, 4b). The locations of the slits 116 depend on where the fins 108 are to be bent relative to the center panel 106. The slits 116 are formed in an exterior wall of the corrugation, preferably at an angle 118 (FIGS. 3b and 3d) relative to normal to the planar center panel. Preferably, each slit 116 is formed in a wall of the planar portion at an angle 118, that is 10 to 80 degrees, and preferably between 40 and 50 degrees, relative to normal to the planar center panel. Cutting the slits at an angle, and in the orientation illustrated, enables the fins 108 to be bent relative to the planar center panel 106 without interference from the remainder of the corrugated material, because the slits can slide passed each other when the fins are bent. Alternatively the slits could be cut mirror image, i.e. at 100 to 170 degrees.

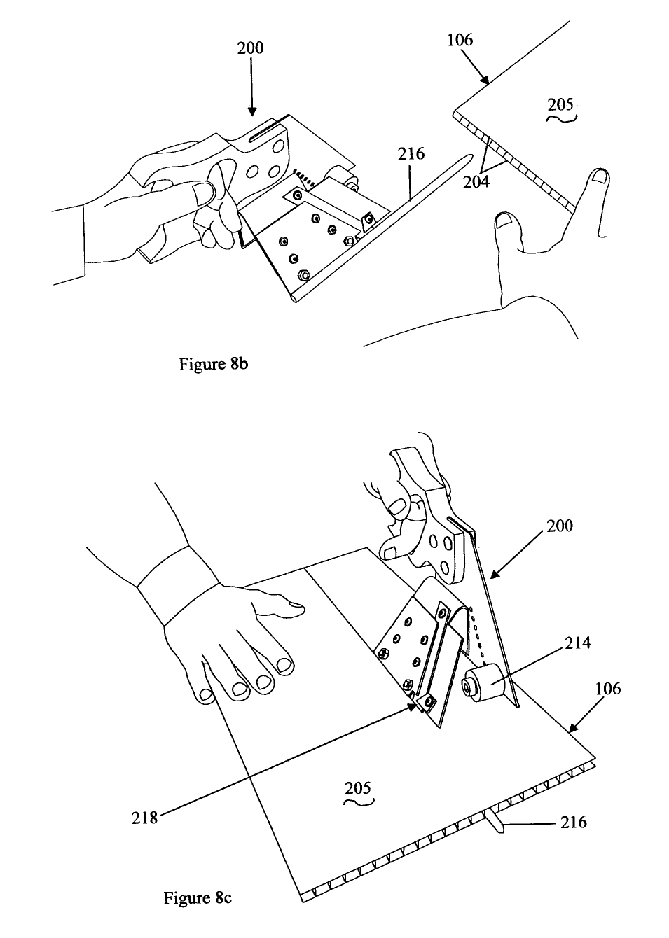

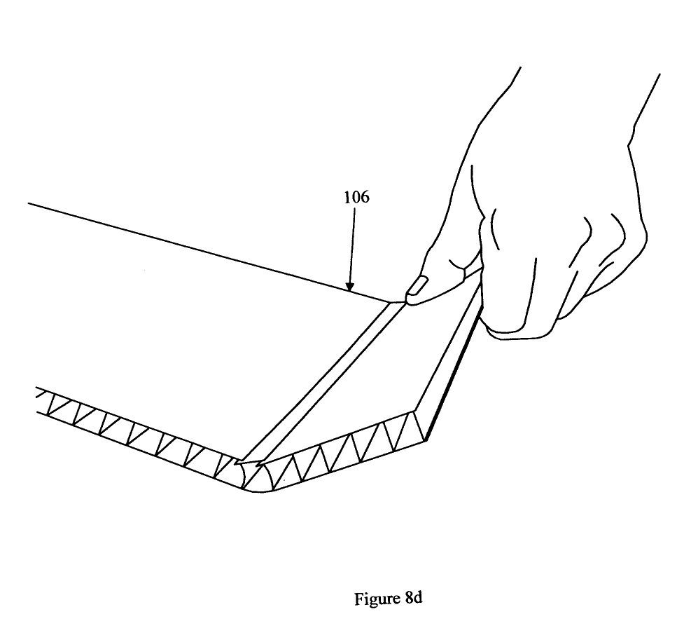

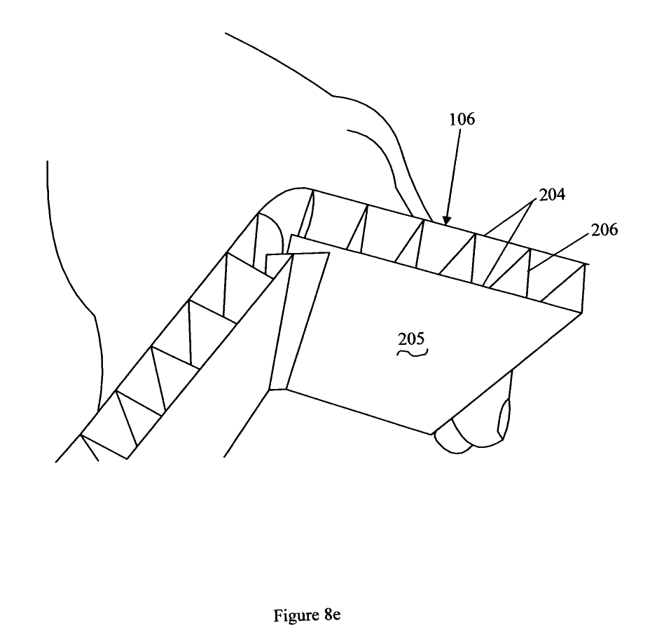

A tool 200 (also referred to as a Slicer) for use in slicing a corrugated panel is illustrated in FIGS. 8a-8e and in Exhibits A1-A4. A corrugated panel 106 that is sliced by the tool 200 is formed of a synthetic material such as Coroplast (described further below) and includes a pair of generally parallel walls 204 and connecting webs 206 between the walls (see FIGS. 2a, 8e and Exhibit A3). One of the walls 204 is sliced, in a direction parallel to the webs 206, to enable a portion of the corrugated panel to be bent out of the plane of the main panel to form a fin on each of the outboard edges.

The tool 200 comprises a support 210, a handle 212, a guide rod 216, and a slicing blade 218 connected with the support. In addition, a surface roller 214 is connected with the handle 212. The guide rod 216 is configured and oriented to be inserted into a corrugation in a panel. The surface roller 214 is configured and oriented to roll along the surface 205 of one of the walls 204 of a panel 202 when the guide rod 216 is in a corrugation in the panel. The slicing blade 218 is configured and oriented to slice through the wall 204 of the panel on which the surface roller 214 rolls, at a predetermined angle to the surface 205 of the panel wall 204. The handle 212 is configured and oriented to enable a user to hold the tool, insert the guide rod 216 into a corrugation in the panel with the surface roller 214 disposed on the surface 205 of the panel, and push the tool 200 along the surface 205 of the panel, so as to slice the surface of the panel at the predetermined angle with the blade. Once the guide rod 216 of the Slicer has gone into a corrugation, it brings the edge of the blade of the Slicer in contact with the outer edge of the wall 204 of the panel. The blade is at an angle of from 10 to 80 degrees (relative to surface 205) and will then make a slice cut in the wall 204 at that angle. The surface roller 214 is configured to roll on surface 205 of the corrugated panel wall 204 to insure a smooth cut of the panel wall.

As the slicing tool is moved along the surface 205 of the corrugated panel in a direction parallel to the connecting webs, the wall 204 of the panel is sliced at a predetermined angle. This forms the slits 116 in the panel. Cutting the slits at an angle of from 10 to 80 degrees allows the edge portion of the corrugated panel to be bent in the direction of the slits (FIGS. 8d, 8e, Exhibit A3), without the sliced portions binding while being bent. Instead the angled slits allows the two cut pieces to slide over/under each other, making the folding the outside angle very easy without any binding of the cut areas (FIG. 8e and Exhibit A3). If the cuts are made at 90 degrees it is difficult if not impossible to bend the edge portion relative to the main panel.

When it is desired to provide two fins in the panel, that are bent out of the plane of the panel, each fin is produced by moving the slicing tool along the surface 205 of the wall 204 of the panel, at least once and preferable twice, along adjacent corrugations of the panel, to form a pair of slices in the wall 204 of the panel, along adjacent corrugations of the panel. If only one slice is used the angle at which the panel can be bent is limited. Then the panel is bent at those slices, in a direction such that that the slices in the one surface can slide under each other, thereby to facilitate bending the panel in the one direction, to form the fin (FIGS. 8d, 8e, Exhibit A3). The support wires 120, described below, are provided in the bent fins, in the manner described below, to maintain the fins in the bent condition.

It is preferred that one or more structural supports extend at least partially in the planar center panel 106 and at least partially into a fin 108 to maintain the fin bent relative to the center panel 106. Referring to FIGS. 4a, 4b, each structural support is preferably a support wire 120 (e.g. formed of copper or another metal that is easily bent) that extends at least partially in the planar center panel and at least partially in a fin 108 that is bent relative to the center panel 106, to maintain the fin bent relative to the center panel 106. The wire 120 can be inserted in openings in the center panel and the fin, before the fin is bent out of the plane of the center panel. Since the wire is malleable, it can be conveniently bent when the fin is bent relative to the center panel. However, the malleable metal wire 120 is rigid enough that when the fin 108 has been bent relative to the center panel 108, the wire 120 will hold the fin in the bent configuration during normal operation of the sign. The cross section of the wire 120 can be any shape (e.g. round, square, rectangular, oval, etc.)

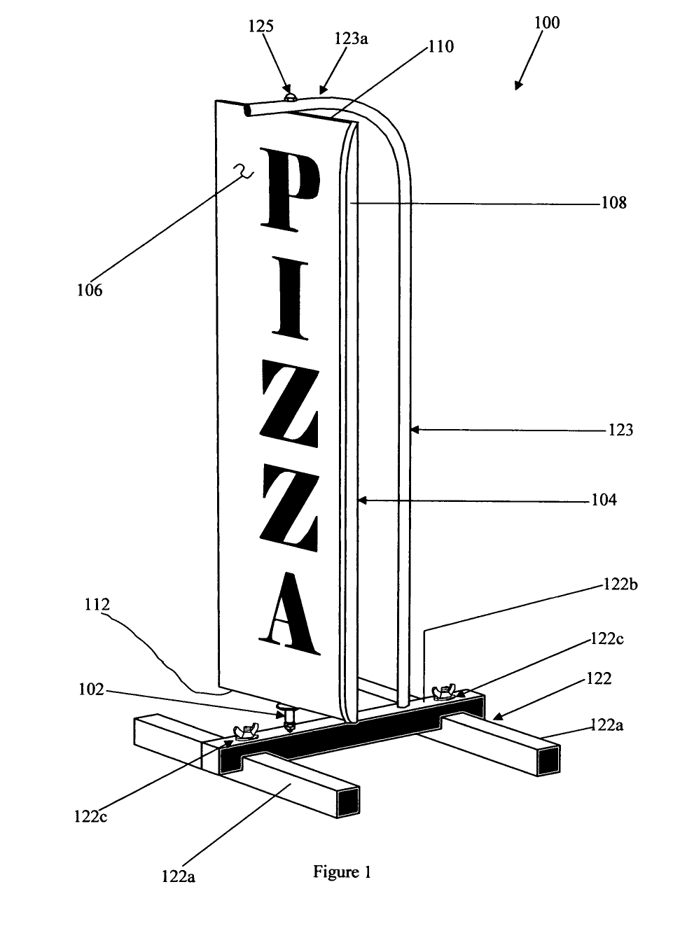

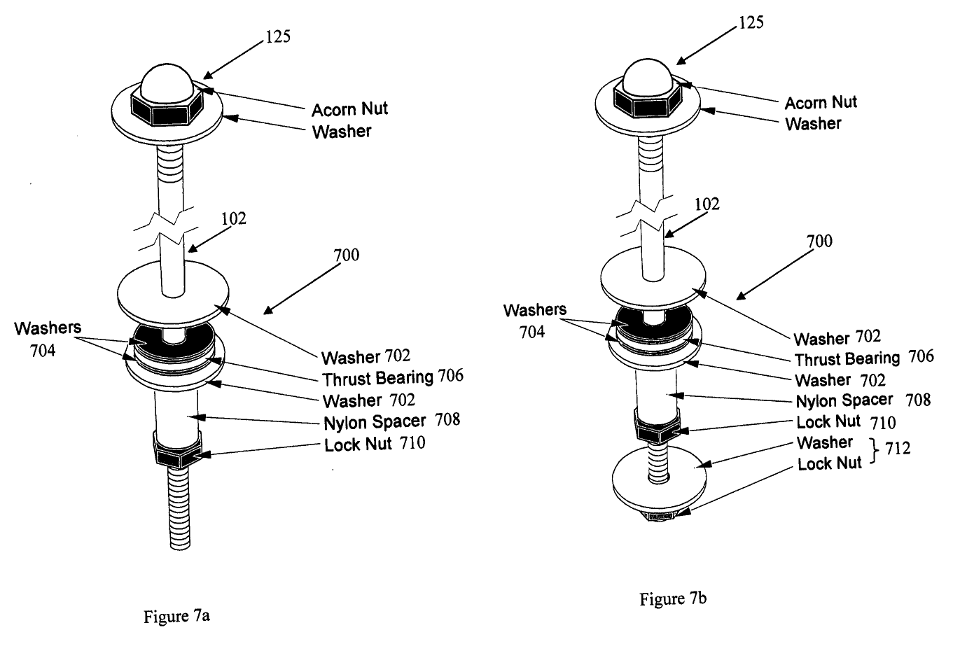

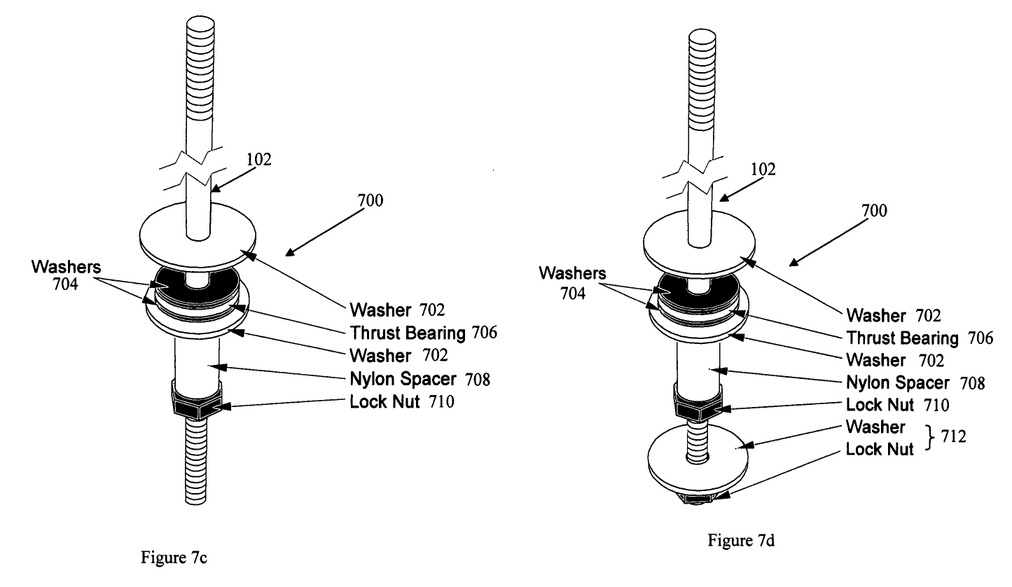

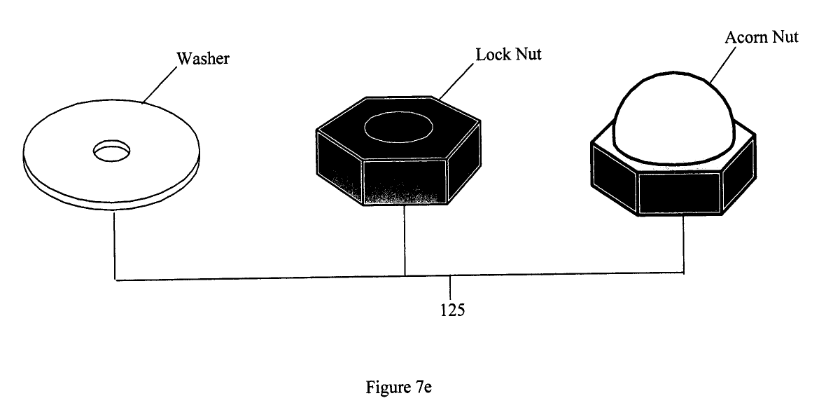

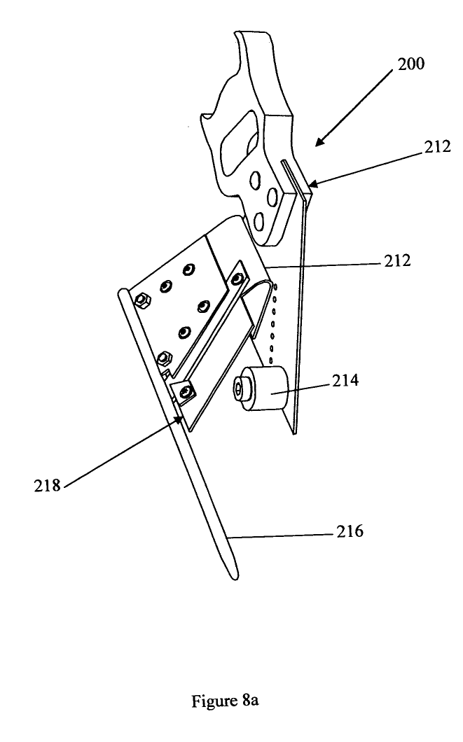

In the embodiment of FIG. 1 the sign includes a base 122 that is configured to rest on a surface. The base 122 comprises parallel bottom pieces 122a and a cross piece 122b that is notched to fit the bottom pieces and is coupled to the bottom pieces, e.g. by bolt, washer and wing nut assemblies 122c. The bottom pieces and cross piece are preferably formed of material known in the trade as “plastic lumber”. A post 123 is connected to and extends upward from the base 122. The post has an upper portion 123a that is bent to a generally horizontal orientation when the post is supported on the base. The support rod 102 extends upward from the cross piece 122b of the base and is coupled with the cross piece 122b and the horizontal portion 123a of the post. As illustrated in FIGS. 7a-7d, the support rod 102 can have threaded upper and lower ends. In the embodiment of FIG. 1, the lower threaded end of the support rod can be screwed into an opening in the cross piece 122b of the base. The upper threaded end of the support rod 102 extends through an opening in the horizontal portion 123a of the post, and is coupled with the portion 123a by a washer, lock nut and acorn nut assembly 125 (FIGS. 7a, 7b, 7e). The corrugated sign 104 is inserted onto the support rod 102, by inserting the support rod through the central corrugation 114 that includes the bearing 113. Bearing and support structure, described further below, provides bearing support for the sign, and allows the sign 104 to easily rotate on the support rod 102.

FIGS. 7a-7d schematically illustrate examples of bearing and support structure 700 for the sign. The bearing a support structure comprises a pair of larger washers 702, smaller washers with a thrust bearing 706 between those smaller washers, a spacer 708 (e.g. a nylon sleeve) and a lock nut 710. Those components enable the sign to rest on one of the large washers 702, and to rotate easily on that large washer. The lock nut 710 enables the position of the bearing and support structure to be adjusted (to some extent) along the support rod 102, to allow a degree of vertical adjustment of the position of the sign. In addition, a lock nut and washer assembly 712 can be provided at the bottom of the support rod, so that rather than screwing the lower end of support rod into an opening in cross piece 122b, the threaded lower end of the support rod can extend through a hole in the cross piece 122b, and the lower lock nut and washer assembly 712 can be tightened to couple the lower end of the support rod to the cross piece 122b.

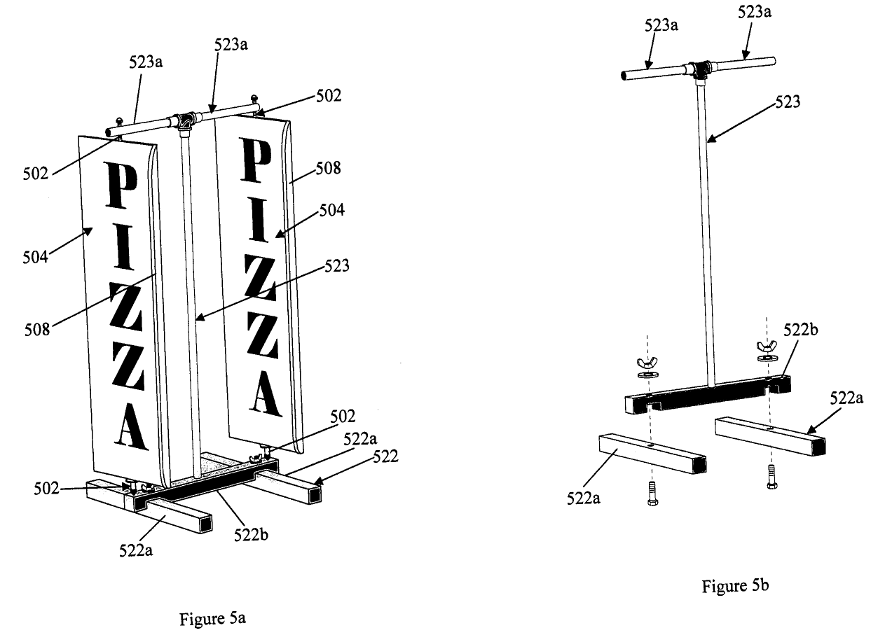

FIG. 5a shows another embodiment of a sign structure, according to the present invention, and FIGS. 5b-5d show how the sign structure is assembled. The sign structure of FIG. 5a includes a base 522 with parallel lower pieces 522a and a cross piece 522b that are similar to the base of FIG. 1. A central post 523 extends upward from the cross piece 522b, and has horizontal top sections 523a. A pair of support rods 502 are provided, each of which is coupled with the cross piece 522b and a horizontal top section 523a, in a manner similar to the embodiment of FIG. 1. The base 522 and post 523 are initially assembled in the manner schematically illustrated in FIG. 5b. The support rod 520 is then inserted through the central corrugation in the sign 504, the lower end of the sign is coupled with the cross piece 522b, in the manner schematically illustrated in FIG. 5c, and the upper end of the support rod 502 is coupled with the horizontal top section 523a of the post, as schematically illustrated in FIG. 5d (essentially in the same way as described above in connection with FIG. 1).

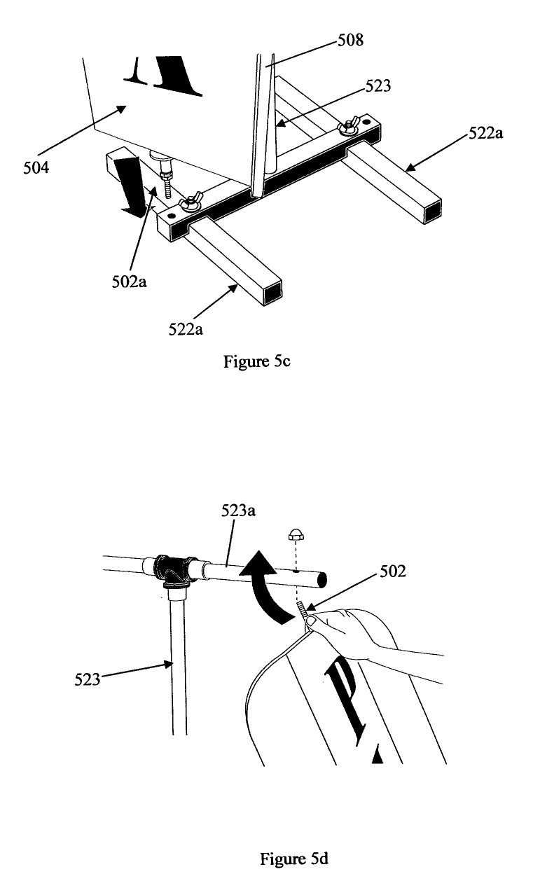

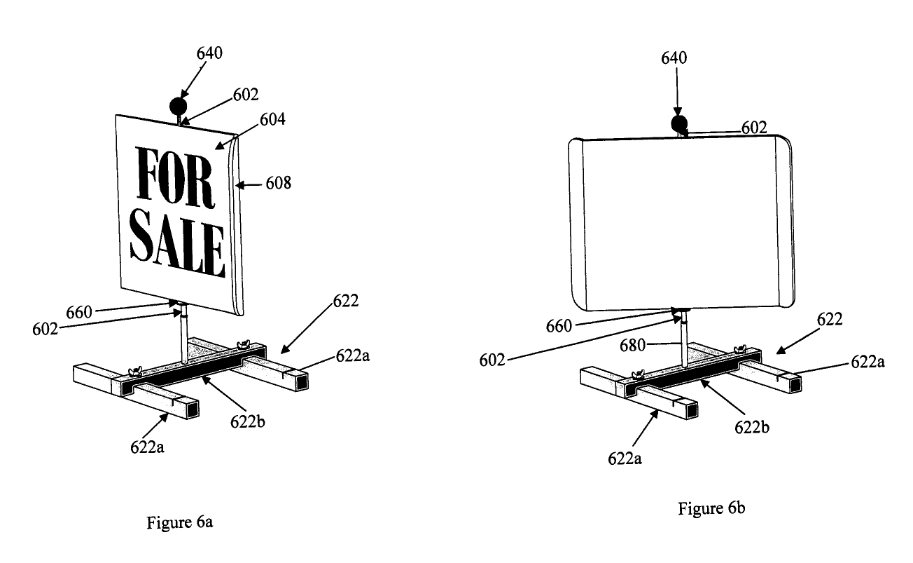

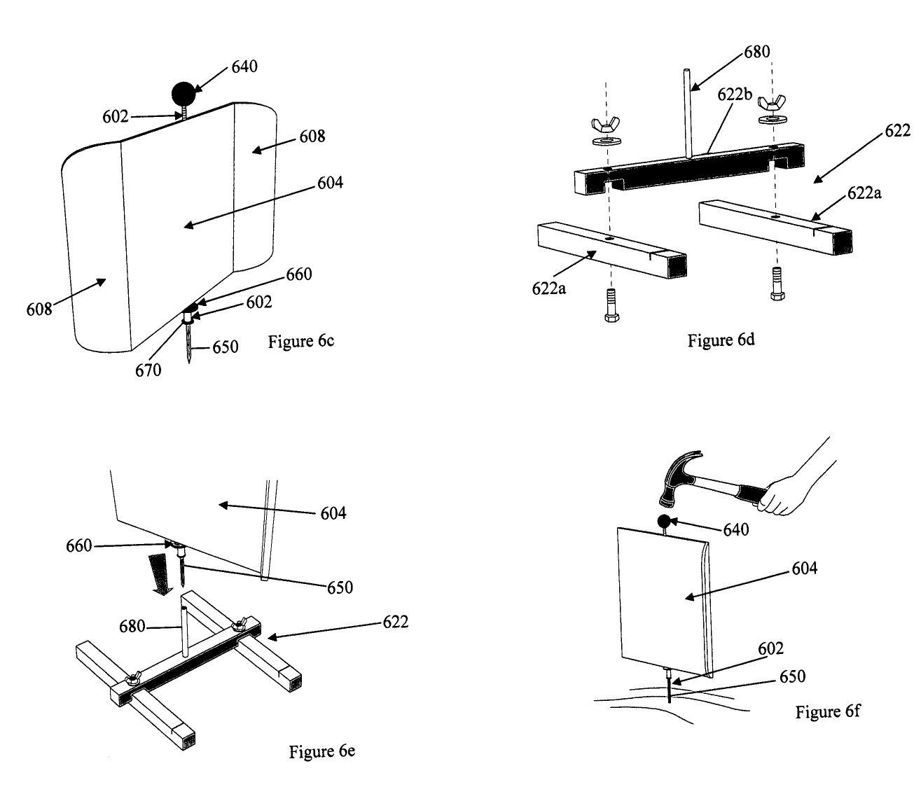

FIGS. 6a, 6b and 6c schematically illustrate some other sign structures according to the present invention. In FIGS. 6a and 6b, a base 622 is provided, and includes parallel pieces 622a and a cross piece 622b similar to the base of the previous embodiments. The support rod 602 and sign 604 are shown in FIG. 6c. The support rod has a knob shaped member 640 that can be formed, e.g. by synthetic ball shaped material that is formed about a threaded insert (not shown). The threaded insert can be screwed onto the threaded top end of the support rod 102, to couple the knob shaped member 640 to the support rod. The support rod 602 has a pointed lower end 650 that effectively forms a stake. The sign 604 is a corrugated panel with bent fins 608, as illustrated and described above. The support rod 602 is inserted through a central corrugation in the panel, and that central corrugation forms a bearing surface for the sign, as described above. At the bottom of the sign, a large washer and spacer assembly 660 are provided, and they are held on place by a self locking retainer ring 670 (FIG. 6c) below the spacer.

The sign structure of FIG. 6c can be directly inserted into the ground. Specifically, the stake 650 formed at the lower end of the support rod enables the sign structure to pierce the ground, and the support rod can be forced into the ground, e.g. with a hammer, as illustrated in FIG. 6f. In addition, the base can have an upwardly extending hollow post 680 (FIGS. 6b, 6d, 6e), so that the pointed lower end of the support rod can be simply inserted into the post, as illustrated in FIG. 6b.

A sign 104 (504, 604) can be easily changed, by uncoupling the acorn nut, lock nut and washer assembly (FIGS. 1, 5a) or unscrewing the knob shaped member 640 (FIGS. 6a-6f), sliding one sign (and if necessary the associated bearing structure of FIGS. 7a-7d) off the support rod, sliding a new sign (and bearing structure) onto the support rod, and recoupling the support rod with the base and post (FIGS. 1, 5a) or reattaching the knob shaped member 640 onto the top of the support rod (FIGS. 6a-6f).

As should be clear to those in the art, the sign structure described above enables the sign structure to be easily and efficiently assembled, and easily and efficiently disassembled and then reassembled, to enable the particular sign panel to be changed. In assembling the sign structure, a corrugated sign is selected, the support rod is inserted into the central corrugation, the desired bearing structure inserted onto the support rod, and the support rod coupled with a base, or pressed into the ground, in the manner described above. In order to disassemble the sign structure, any coupling structure associated with the support rod is uncoupled, the sign panel (and any bearing structure necessary) is slid off the support rod. Then, if a new sign panel is selected, that new sign panel is slid onto the support rod, the bearing structure slid back onto the support rod (if the bearing structure had been removed), and the support rod either pressed into the ground, or coupled with the base, to reassemble the sign structure with the new selected sign.

In all of the foregoing embodiments, the sign is preferably formed of extruded plastic, e.g. of a material known as Coroplast (Coroplast Inc, Quebec, Canada; Dallas, Tex.) As explained in the manufacturer's literature, the material is preferably extruded corrugated plastic, produced from a high impact polypropylene copolymer, which is chemically inert and has a NIL pH factor. Moreover, as further explained by the manufacturer's literature, the material can optionally have features like ultra violet protection, flame retardant, custom colors, corrosion inhibitors, static-dissipation, etc, that are melt blended into the plastic material. The support rod 102 is preferably formed of metal. The bearing and support structure 128 at the lower end of the sign can be selectively located in a predetermined position along the support rod.

Thus, the present invention provides a sign structure that is conveniently formed and assembled. While the sign is preferably formed of corrugated material, it will be appreciated that the sign structure may also comprise a panel formed in one piece with the bearing surface, where the panel extends laterally from the bearing surface, and the lateral ends of the panel include fins formed in one piece with the panel, the fins configured to allow air movement in the vicinity of the panel to rotate the panel about the central axis.

Accordingly, the foregoing disclosure provides sign structure that is (i) efficient and cost effective to produce, (ii) easily and efficiently assembled, in order to change the message conveyed by the sign structure, and (iii) effectively rotated by the air in the vicinity of the sign structure, to attract the attention of those in viewing range of the sign structure. Specifically, as seen from the foregoing description, a sign can be easily and efficiently produced, with a center panel and a pair of fins, from the corrugated synthetic material. The preferred embodiment describes a way of configuring the corrugated material so that the fins can be easily bent from the corrugated material and maintained in a bent state. The synthetic corrugated material is relatively lightweight (in comparison to an aluminum sign), and is relatively inexpensive relative to produce and efficient to assemble, primarily because the bearing and support structure is simpler and easier to produce and assemble than the special types of bearing structures that have been used in the past.

In addition, the foregoing disclosure provides a tool for use in forming the sign structure, and to a method that uses the tool in forming the sign structure.

With the foregoing disclosure in mind, it is believed that various ways of constructing sign structures, in accordance with the principles of the present invention, will become apparent to those skilled in the art.

1. Sign structure comprising
a. a support rod,
b. a sign comprising a panel and a bearing surface extending along a predetermined portion of the panel, the bearing surface configured to slide over the support rod and to rotate on the support rod, and the panel integrally connected with the bearing surface, so that the panel rotates with the bearing support about the support rod, and
c. the panel comprising a synthetic material having a corrugated configuration with at least one corrugation forming the bearing surface for the panel.

2. Sign Structure as defined in claim 1, wherein the panel extends laterally from a central corrugation that is formed in one piece with the bearing surface for the panel, and the lateral ends of the panel include fins formed in one piece with the panel, the fins configured to allow air in the vicinity of the panel to rotate the panel about the support rod.

3. Sign structure as defined in claim 2, wherein the panel includes a planar portion, and the fins extend angularly in opposite directions out of the planar portion.

4. Sign structure as defined in claim 3, wherein the fins are bent relative to the planar portion.

5. Sign structure as defined in claim 4, wherein each fin is bent at one or more slits formed in one exterior wall of the corrugated panel at an angle between 10 and 80 degrees relative to the planar portion and being oriented to allow the fin to be bent relative to the planar portion without interference from the remainder of the corrugated panel.

6. Sign structure as defined in claim 5, wherein one or more support structures extend at least partially in the planar portion and at least partially into a fin to maintain the fin bent relative to the planar portion.

7. Sign structure as defined in claim 4, wherein support structure extends at least partially in the planar portion and at least partially into each fin to maintain the fins bent relative to the planar portion.

8. Sign structure comprising
a. a support rod having a central axis, and
b. a sign comprising a panel and a bearing surface extending along a predetermined portion of the panel, the bearing surface extending about the central axis and configured to slide over the support rod and to engage the support rod, and the panel formed in one piece with the bearing surface, and
c. the panel extending laterally from the bearing surface, and the lateral ends of the panel include fins formed in one piece with the panel, the fins configured to allow air movement in the vicinity of the panel to rotate the panel about the central axis.

9. Sign Structure as defined in claim 8, wherein the support rod and the bearing surface are configured such that the panel can rotate about the central axis.

10. Sign Structure as defined in claim 8, wherein the support rod and the bearing surface are configured such that the panel and the support rod can rotate about the central axis.

11. Sign structure as defined in claim 8, wherein the panel includes a planar portion, and the fins extend angularly in opposite directions out of the planar portion.

12. Sign structure as defined in claim 11, wherein the fins are bent relative to the planar portion, and support structure extends at least partially into the planar portion and at least partially into each fin to maintain the fin bent relative to the planar portion.

13. Sign structure as defined in claim 11, wherein the panel is a corrugated member and the fins are bent relative to the planar portion, each fin being bent at one or more slits in the corrugations, the slits being formed in a wall of the corrugation and being oriented to allow the fin to be bent relative to the planar portion without interference from the other side of the slit.

14. Sign structure as defined in claim 13, wherein support structure extends at least partially into the planar portion and at least partially into a fin to maintain the fin bent relative to the planar portion.

15. Sign support structure as defined in claim 1, further including a frame for supporting the support rod.

16. Sign support structure as defined in claim 1, wherein the panel is formed of extruded plastic.

17. Sign support structure as defined in claim 1, wherein the panel is formed of corrugated synthetic material.

18. Sign support structure as defined in 1, further including thrust bearing structure that can be selectively located along the support rod.

19. A tool for use in slicing a corrugated panel formed by a pair of generally parallel walls and connecting webs between the walls, to enable a portion of the corrugated panel to be bent out of the plane of the panel, comprising a support, a handle, a guide rod and a slicing blade connected with the support, and a surface roller connected with the handle; the guide rod configured and oriented to be inserted into a corrugation in a panel; the surface roller configured and oriented to roll along a surface of a wall of a panel when the guide rod is in a corrugation in the panel; the slicing blade configured and oriented to slide through the wall of the panel on which the guide roller rolls, at a predetermined angle to the wall; and the handle configured and oriented to enable a user to hold the tool, insert the guide rod into a corrugation in the panel with the surface roller disposed on a surface of the wall of the panel, and push the tool along the surface of the wall of the panel so has to slice the wall of the panel at the predetermined angle with the blade.

20. A method of forming a corrugated panel that is formed by a pair of generally parallel walls and connecting webs between the walls, comprising the steps of providing a slicing tool, and moving the slicing tool along one of the walls of the corrugated panel in a direction parallel to the connecting webs at a predetermined angle to the one of the walls, to slice the one of the walls at the predetermined angle.

21. A method as set forth in claim 20, including the further step of moving the slicing tool along the wall at least twice, along adjacent corrugations of the panel, to form a pair of slices in the wall of the panel, along adjacent corrugations of the panel.

22. A method as set forth in claim 21, further including bending the panel in a direction such that that the slits in the one wall can slide under each other, thereby to facilitate bending the panel in the one direction.

23. A method as set forth in claim 22, wherein the step of providing a tool comprises providing a tool having a support, a handle, a guide rod and a slicing blade connected with the support, and a surface roller connected with the handle; the guide rod configured and oriented to be inserted into a corrugation in a panel; the surface roller configured and oriented to roll along a surface of a wall of the panel when the guide rod is in a corrugation in the panel; the slicing blade configured and oriented to slice through the wall of the panel on which the surface roller rolls, at a predetermined angle to the wall; and the handle configured and oriented to enable a user to hold the tool, insert the guide rod into a corrugation in the panel with the surface roller disposed on a surface of the wall of the panel, and push the tool along the surface of the wall of the panel so has to slice the wall of the panel at the predetermined angle with the blade.
